(19) United States
(12) Patent Application Publication
(10) Pub. No.: US 2019/0357310 A1
(43) Pub. Date: Nov. 21, 2019

(54) METHODS, SYSTEMS, APPARATUSES AND DEVICES FOR FACILITATING CONTROLLING OF A HEATING DEVICE

(71) Applicant: Alexis Geacintov, Huntsville, AL (US)

(72) Inventor: Alexis Geacintov, Huntsville, AL (US)

(21) Appl. No.: 16/415,835

(22) Filed: May 17, 2019

Related U.S. Application Data
(60) Provisional application No. 62/673,654, filed on May 18, 2018.
(60) Provisional application No. 62/776,942, filed on Dec. 7, 2018.

(51) Int. Cl. H05B 1/02; F23D 14/72; F24C 15/10; F27D 21/04

(52) U.S. Cl. CPC H05B 1/0266; F23D 14/72; H05B 2213/04; F27D 21/04; F24C 15/105

(57) ABSTRACT

Disclosed herein is an apparatus to facilitate controlling of a heating device. Further, the apparatus may include at least one transducer configured to detect at least one environmental variable associated with an output device of a pre-deployed sensor unit. Further, the apparatus may include at least one actuator coupled to the heating device. Further, the at least one actuator may be configured for controlling an operational state of the heating device. Further, the apparatus may include a processing device communicatively coupled to each of the at least one transducer and the at least one actuator. Further, the processing device may be configured for controlling the operational state of the heating device based on the detection of the at least one environmental variable.

### FIELD OF THE INVENTION

Generally, the present disclosure relates to the field of data processing. More specifically, the present disclosure relates to methods, systems, apparatuses and devices for facilitating controlling of a heating device.

### BACKGROUND OF THE INVENTION

Generally, kitchen fires are the major reason behind home fires and injuries caused by it. Occupants must never underestimate the speed and power of fire in a closed environment such as houses, travel trailers, and boats. Even a small fire may turn devastating in a short period of time.

A study by the National Fire Protection Association in 2017 shows that cooking equipment was the leading cause of home structure fires and civilian fire injuries and the second leading cause of home fire deaths. Moreover, unattended cooking was by far the leading contributing factor in these fires and in fire casualties. Generally, present house safety equipment such as smoke detectors usually just notify the occupants rather than stopping the fire. Nowadays, smart home systems are coupled with sensors such as smoke detectors using Wi-Fi or Bluetooth.

Some patents disclose devices for interrupting power to appliances in the event of a fire, for example, U.S. Pat. No. 2014/0375144 A1, U.S. Pat. Nos. 5,508,568, 6,130,412, and 4,659,909. It is believed that none of the above patents, either taken singly or in combination, have the advantages of the present disclosure as claimed.

Therefore, there is a need for improved methods, systems, apparatuses and devices for facilitating controlling of a heating device that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus to facilitate controlling of a heating device. Further, the apparatus may include at least one transducer configured to detect at least one environmental variable associated with an output device of a pre-deployed sensor unit. Further, the apparatus may include at least one actuator coupled to the heating device. Further, the at least one actuator may be configured for controlling an operational state of the heating device. Further, the apparatus may include a processing device communicatively coupled to each of the at least one transducer and the at least one actuator. Further, the processing device may be configured for controlling the operational state of the heating device based on the detection of the at least one environmental variable.

Further disclosed herein is an apparatus to facilitate controlling of an electrical appliance. Further, the apparatus may include at least one transducer configured to detect at least one environmental variable associated with an output of a pre-deployed sensor unit. Further, the apparatus may include at least one actuator coupled to the heating device. Further, the at least one actuator may be configured for controlling an operational state of the heating device. Further, the apparatus may include a processing device communicatively coupled to each of the at least one transducer and the at least one actuator. Further, the processing device may be configured for controlling the operational state of the heating device based on the detection of the at least one environmental variable.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of an apparatus to facilitate controlling of a heating device, in accordance with some embodiments.

FIG. 3 is a block diagram of a system to facilitate controlling of a gas stove through an apparatus, in accordance with some embodiments.

FIG. 4 is a block diagram of a system to facilitate controlling of an electric stove through an apparatus, in accordance with some embodiments.

FIG. 5 is a block diagram of an apparatus including a power source to facilitate controlling of a heating device, in accordance with some embodiments.

FIG. 6 is a block diagram of an apparatus comprising a transceiver to facilitate controlling of a heating device, in accordance with some embodiments.

FIG. 7 is a block diagram of an apparatus comprising a memory device to facilitate controlling of a heating device, in accordance with some embodiments.

FIG. 8 is a block diagram of an apparatus to facilitate controlling of an electrical appliance, in accordance with some embodiments.

FIG. 9 is an exemplary illustration of an apparatus to facilitate a user with an override feature to control an actuator of the apparatus when a false alert signal is received, in accordance with some embodiments.

FIG. 10 is a block diagram of an apparatus to facilitate a user with an override feature to control the apparatus when a false alert signal is received using a wireless communication network, in accordance with some embodiments.

FIG. 11 is a block diagram of an apparatus to facilitate a user with an override feature to control an actuator of the apparatus when a false alert signal is received by the apparatus, in accordance with some embodiments.

FIG. 12 is an exemplary illustration of an apparatus to facilitate a controlling operational state of an electric stove, in accordance with some embodiments.

FIG. 13 is an exemplary illustration of normally open electrically operated solenoid valve in an open state, in accordance with some embodiments.

FIG. 14 is an exemplary illustration of normally open electrically operated solenoid valve in a closed state, in accordance with some embodiments.

FIG. 15 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of controlling of a heating device, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview

The ‘fire sentry’ is a device that receives a wireless signal from any typical home automation system that instantly shuts of the gas supply or electrical power to your stove whenever a smoke alarm is triggered. The fire sentry may be compatible with third-part systems such as the Wink® hub, Amazon® Echo, Alexa, Google® Home, Logitech® Harmony Hub, or Samsung® Smartthings hub or smoke alarms capable of transmitting signals. Upon receiving a signal from a smoke alarm, the power to either a gas or electric stove is immediately shut off. The fire sentry sends a signal to an application accessible on a smartphone, computer, or tablet notifying the user anywhere where the smartphone, computer or tablet has internet access, allowing the user to override the shutoff. If the user does not have a smart home compatible smoke detector the ‘voice recognition’ function of the smart home system can be programmed to detect the sound of the smoke alarm, sending a signal to the fire sentry to shut off the stove.

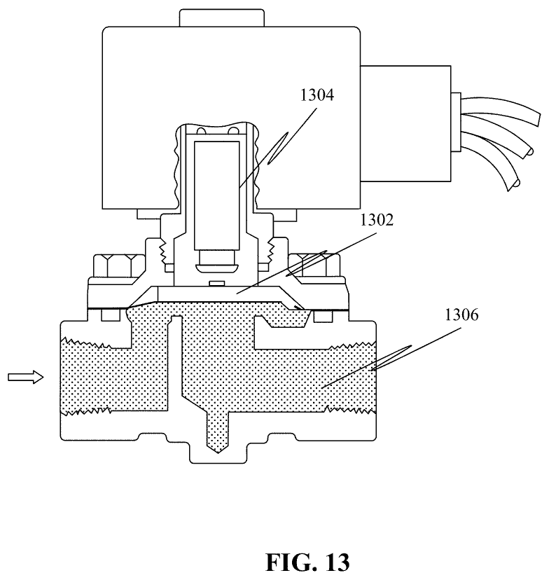

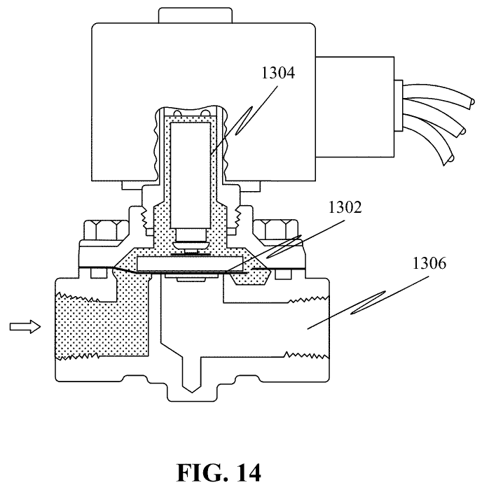

For a gas stove, the device may consist of a wireless receiver such as ESP8266 wireless receiver and a relay connected to a normally open electrically operated solenoid valve 1300. When a Wi-Fi signal is received by the wireless receiver from one or more smartphones, a home automation system and a smoke alarm, then a relay immediately closes, allowing an electrical signal to energize a solenoid 1304 associated with the valve 1302. Further, the valve 1302 may then be closed as illustrated in FIG. 14. Once the electrical signal is removed the valve may reopen, allowing gas to flow through a fuel supply line, as shown in FIG. 13. In its normal condition, the electromagnet in the solenoid is not energized and the device draws no amperage.

The fire sentry device may replace a standard gas line which may runs between the fuel supply line and the stove and is powered by the standard household current. The gas line may be replaced with the fire sentry and the unit is either plugged into an electrical outlet or it can be ‘hard-wired’ into the kitchen electrical circuit.

For an electric stove such as an induction heater, the Wi-Fi receiver is integrated into a standard appliance outlet. The standard appliance outlet is replaced with the fire sentry and the stove is plugged into the outlet as usual. When triggered, the relay interrupts the electrical power to the electric stove. A circuit breaker switch mounted on the upper cabinet is triggered, locking the relay, requiring the user to manually override the relay by resetting the circuit breaker switch. The electrical fire sentry receives a signal from the home automation system, or directly from the smoke alarm, or may react to the alarm sound to disable the electric stove.

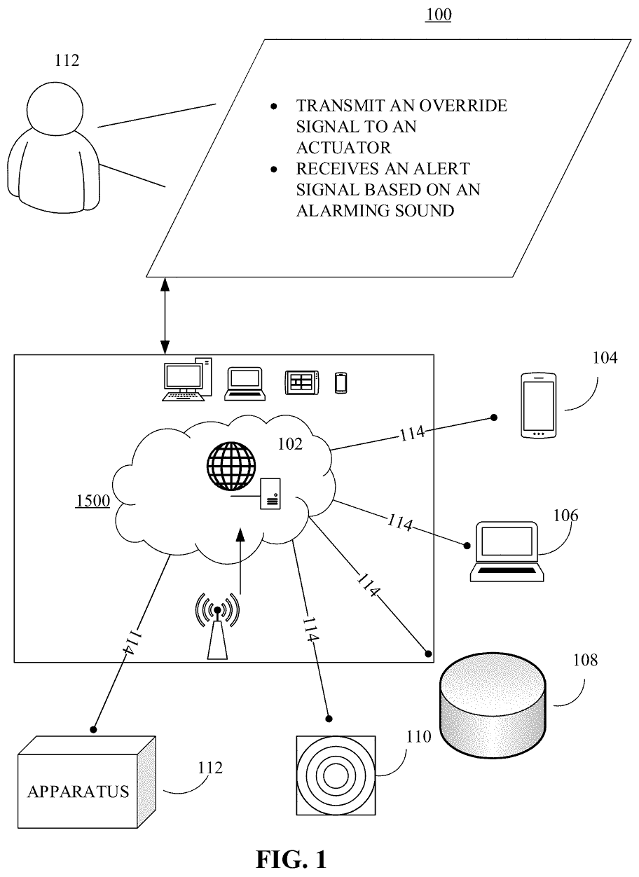

FIG. 1 is an illustration of an online platform 100 consistent with various embodiments of the present disclosure. By way of non-limiting example, the online platform 100 to facilitate controlling of a heating device may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 and an apparatus 112 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 500.

According to some embodiments, the online platform 100 may be provided to facilitate a user with an override feature to control an actuator when a false alert signal is received. The online platform 100 may be configured to communicate with a user device. The user device may be a mobile device such as, but not limited to, a smartphone, a computer tablet, a laptop, and so on. The user device may include a communication device configured to communicate over a communication network such as, but not limited to, a cellular network, a satellite network, a personal area network, Bluetooth, Internet and so on. Further, the user device may include sensors. The sensors may include, but may not be limited to a camera, microphone, a location sensor, and so on. The actuator may be a component of a machine that may be responsible for moving and controlling a mechanism or system.

Firstly, the online platform 100 may receive an alarming sound that may be produced by a sensor such as a smoke detector. For instance, the user may be cooking and gets disturbed during the process of cooking by a stimulus such as guests. The user may leave the stove in a functioning position and may leave the kitchen in a hurry, without knowing the fact that the food may still be cooking on the stove. After a while, the food may get overcooked or may catch fire. The smoke detector nearby may detect smoke coming out of the food. Accordingly, the smoke detector may produce the alarming sound that may depict as an emergency or a hazardous situation. The alarming sound may be received by the online platform 100 using a transducer such as a microphone over Wi-Fi, or Bluetooth.

In some embodiments, the alarming sound may be analyzed by the online platform 100 using a processing device such as a computer. For an instance, the alarming sound received may be analyzed and compared with different sounds by the processing device in order to determine an alarming signal that may be transmitted to the actuator and may be an alert signal that may be simultaneously transmitted to the user device. Accordingly, the alert signal may notify the user of an emergency or hazardous situation.

Further, the online platform 100 may transmit the alarming signal to the actuator using the communication device. For an instance, the actuator such as a control valve may be embedded with the fuel supply. Accordingly, when the actuator receives the alarming signal, the actuator may close the fuel supply.

Further, the online platform 100 may simultaneously transmit the alert signal to the user device using the communication device. For an instance, a notification herein the alert signal may be transmitted to the user device to notify the user that the food is still cooking on the stove.

Further, the online platform 100 may receive an override signal from the user device using the communication device. For an instance, the user may override the actuator using the user device by transmitting the override signal. The override signal may be a signal to counteract the normal operation of any device such as the actuator. For instance, the user may receive a false alert signal from the online platform 100 as the user may be known of the fact that the origin of alarming sound received by the online platform 100 may be from a television that may be in front of the user. Accordingly, the user may transmit the override signal from the user device may be from an application on the user device, in accordance with some embodiments.

Further, the online platform 100 may transmit the override signal to an actuator using the communication device. Accordingly, the actuator may stop the restriction made by the valve based on the override signal. For instance, the actuator may open the valve again allowing the flow of the fuel.

In some embodiments, the online platform 100 may program, control, or override the actuator without requiring physical access. For example, voice recognition may be utilized to override the actuator.

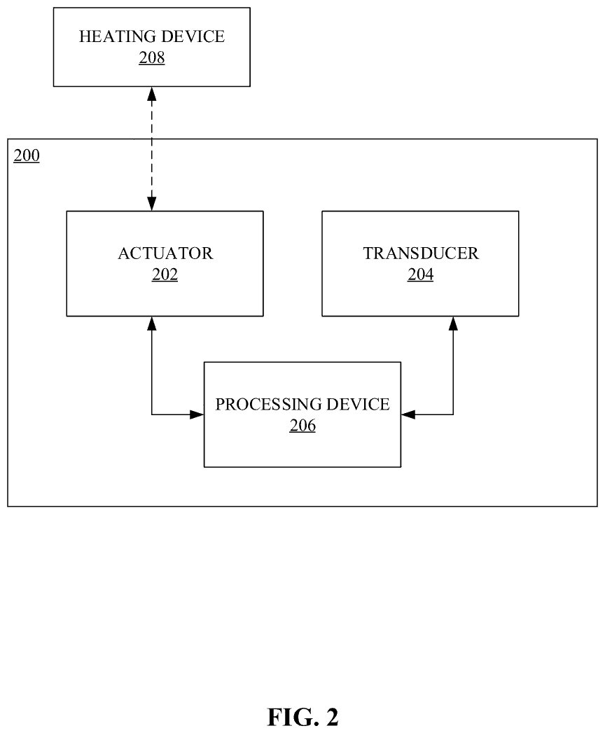

FIG. 2 is a block diagram of an apparatus 200 to facilitate controlling of a heating device 208, in accordance with some embodiments. Further, the heating device 208 may include a device that may be configured to provide heat as an output upon consumption of a power source. For instance, the heating device 208 may include a gas stove. Further, the gas stove may be configured to consume fuel, such as a gas, and produce heat, and flame. Further, in an embodiment, the heating device 208 may include an electric stove. Further, the electric stove may be configured to consume electricity and produce heat and flame. Further, in an instance, the heating device 208 may include an electrical appliance configured to produce heat. For instance, the heating device may include a clothes iron configured to produce heat through consumption of electricity by heating of an electric coil. Further, in an instance, the heating device may include a room heater configured to produce heat through consumption of electricity by heating of an electric coil.

Further, the apparatus 200 may include at least one transducer 204 configured to detect at least one environmental variable associated with an output device of a pre-deployed sensor unit. Further, the apparatus 200 may include at least one actuator 202 coupled to the heating device 208. Further, the at least one actuator 202 may be configured for controlling an operational state of the heating device 208. Further, the apparatus 200 may include a processing device 206 communicatively coupled to each of the at least one transducer 204 and the at least one actuator 202. Further, the processing device 206 may be configured for controlling the operational state of the heating device 208 based on the detection of the at least one environmental variable. Further, in some embodiments, the output device may include a speaker. Further, the at least one transducer 204 may include a sound detector. Further, in some embodiments, the pre-deployed sensor unit may include a smoke alarm configured to generate a sound through the output device upon detection of smoke. Further, in some embodiments, the output device may include a light emitter. Further, the at least one transducer 204 may include a light detector. Further, in some embodiments, the pre-deployed sensor unit may include a fire alarm configured to emit a light pattern through the output device upon detection of a fire. Further, in some embodiments, the at least one transducer 204 may be configured to detect an environmental parameter associated with an environment in which the apparatus 200 may be deployed. Further, the environmental parameter may include at least one of temperature, humidity, pressure, light, sound, vibration, wind and motion of objects. Further, the processing device 206 may be configured for controlling the operational state of the heating device 208 based on the detection of the at least one environmental variable.

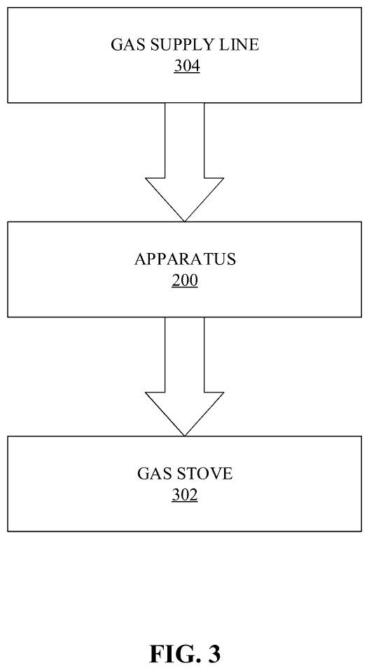

FIG. 3 is a block diagram of a system to facilitate controlling of a gas stove 302 through the apparatus 200, in accordance with some embodiments. Further, the at least one actuator 202 may be configured to stop a flow of fuel to the gas stove 302 by closing a fuel valve in a fuel supply 304 line configured to supply fuel to the gas stove 302. Further, the apparatus 200 may be configured to be positioned between the fuel supply line 304 and the gas stove 302. Further, the apparatus 200 may be configured to act as a conduit for fuel from the fuel supply line 304 to the gas stove 302. Further, the apparatus 200 may include a fuel passage with a first end configured to interface with the fuel supply line 304, and a second end configured to interface with a fuel inlet of the gas stove 302.

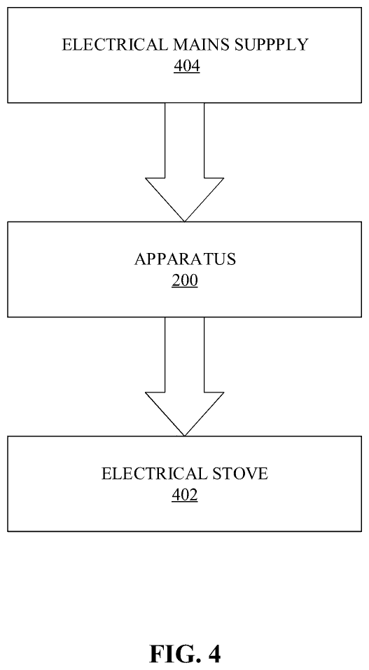

FIG. 4 is a block diagram of a system to facilitate controlling of an electric stove 402 through the apparatus 200, in accordance with some embodiments. Further, the at least one actuator 202 may be configured for controlling supply of electric power to the electric stove 402. Further, the apparatus 200 may include a plug configured to connect to electric mains supply 404. Further, the apparatus 200 may include an electrical outlet electrically coupled to the plug. Further, the electrical outlet may be configured to receive a plug of the electrical stove 402, and transmit electrical power from the electrical mains supply 404 to the electrical stove 402. Further, the apparatus 200 may include a circuit breaker switch electrically coupled to each of the plug and the electrical outlet. Further, the circuit breaker switch may be configured for controlling electrical continuity between the electric mains supply and the electrical outlet. Further, the circuit breaker switch may be communicatively coupled to the at least one actuator 202. Further, the processing device 206 may be configured to activate the circuit breaker switch based on detecting the at least one environmental variable.

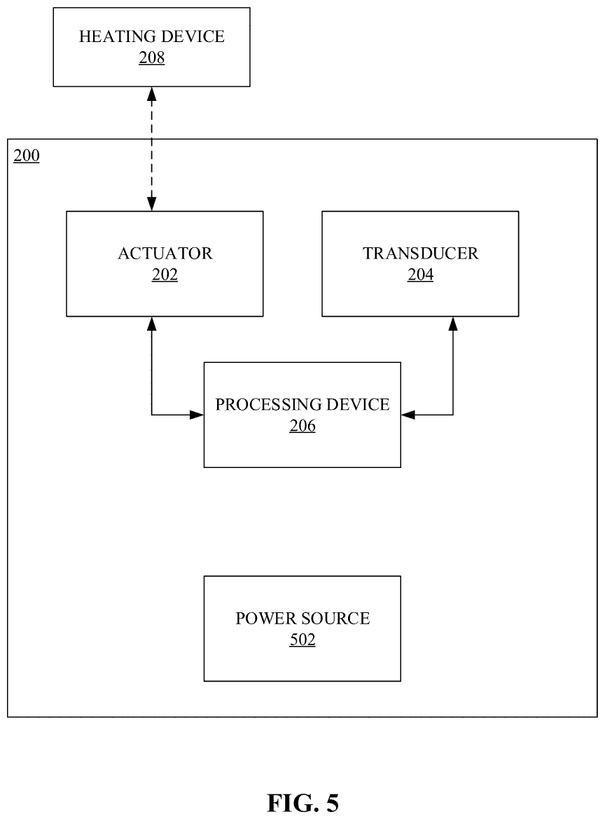

FIG. 5 is a block diagram of an apparatus 200 including a power source 502 to facilitate controlling of a heating device 208. Further, the power source 502 may be configured to power the apparatus. Further, the power source 502 may include at least one of a removable power source, and irremovable power source. Further, the removable power source may include a battery, including, but not limited to a Nickel-Cadmium (NiCd or NiCad) battery, a Nickel metal hydride (Ni-MH) battery, and a Lithium ion (Li-Ion) battery. Further, in an embodiment, the battery may be rechargeable through an external energy source, such as through a wired charger, or through a wireless charger through induction. Further, in an embodiment, the irremovable power source may include a connection to electrical mains, such as through a wired plug.

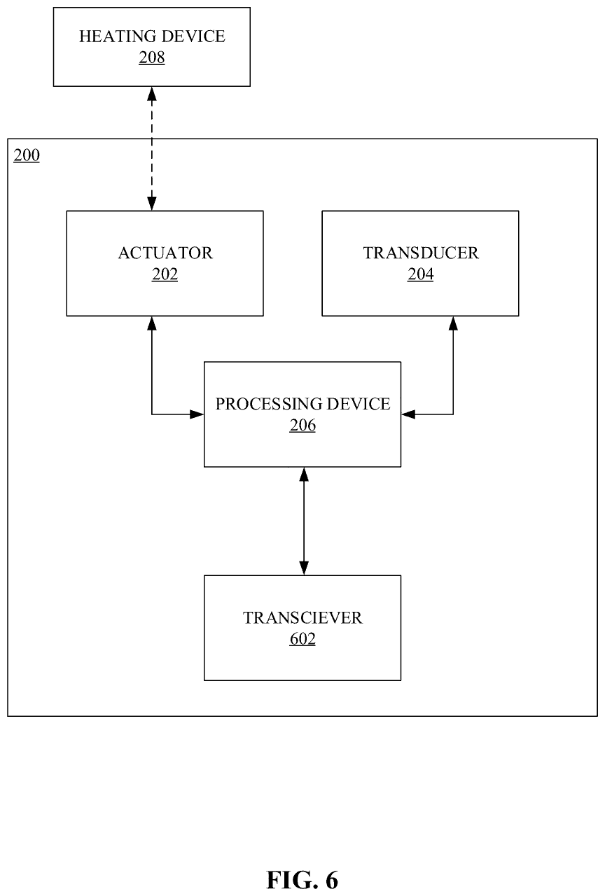

FIG. 6 is a block diagram of an apparatus 200 comprising a transceiver 602 to facilitate controlling of a heating device 208, in accordance with some embodiments. Further, the transceiver 602 may be communicatively coupled to the processing device 206. Further, the transceiver 602 may be configured to communicate with a home automation system associated with a premises of the heating device. Further, in some embodiments, the transceiver 602 may be configured to receive at least one characteristic of the at least one environmental variable associated with the output device from the home automation system, such as over a communication network, such as Wi-Fi, Bluetooth, cellular network, NFC, ZigBee, and so on. Further, the detection of the at least one environmental variable may be based on the at least one characteristic. Further, in some embodiments, the transceiver 602 may be configured to transmit a notification to a user device, such as a smartphone, a computer tablet, a laptop, and so on. Further, the processing device 206 may be configured to generate the notification based on the detection of the at least one environmental variable. Further, in some embodiments, the transceiver 602 may be configured to receive an actuating signal corresponding to the at least one actuator 202 from the user device. Further, the at least one actuator 202 may be configured for controlling the operational state of the heating device based on the actuating signal. Further, in some embodiments, the transceiver 602 may be configured to receive a media content associated with at least one user device connected to the home automation system. Further, the processing device 206 may be configured to analyze the media content. Further, the processing device 206 may be configured to determine a presence of a the at least one characteristic in the media content based on the analyzing. Further, the controlling of the operational state of the heating device may be further based on determining the presence of the at least one characteristic in the media content.

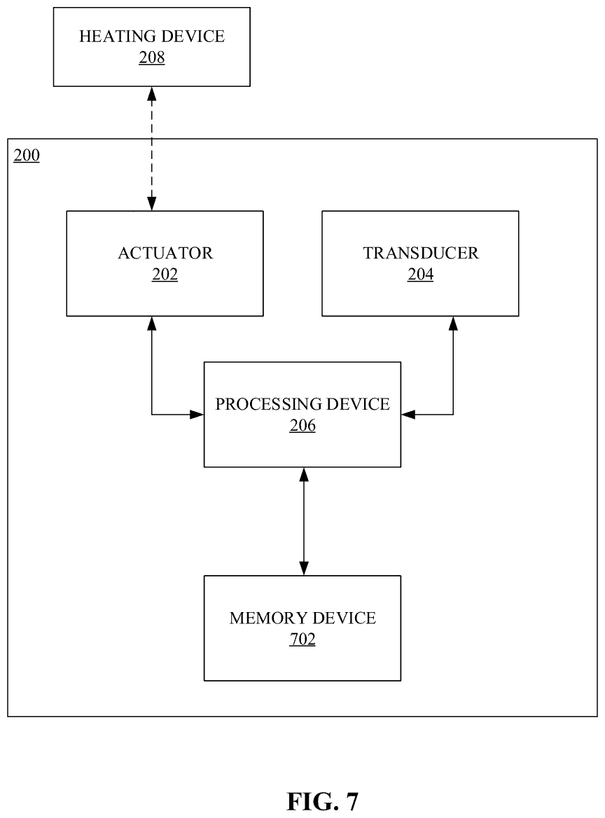

FIG. 7 is a block diagram of an apparatus 200 comprising a memory device 702 to facilitate controlling of a heating device 208, in accordance with some embodiments. Further, the memory device 702 may be communicatively coupled to the processing device 206. Further, the memory device 702 may be configured for storing and retrieving at least one digital signature associated with an output of output device. Further, in some embodiments, the processing device 206 may be configured to compare a signal generated by the at least one transducer 204 with the at least one digital signature to determine an authenticity of the output. Further, the processing device 206 may be configured for controlling the operational state of the heating device 208 based on the determining of the authenticity.

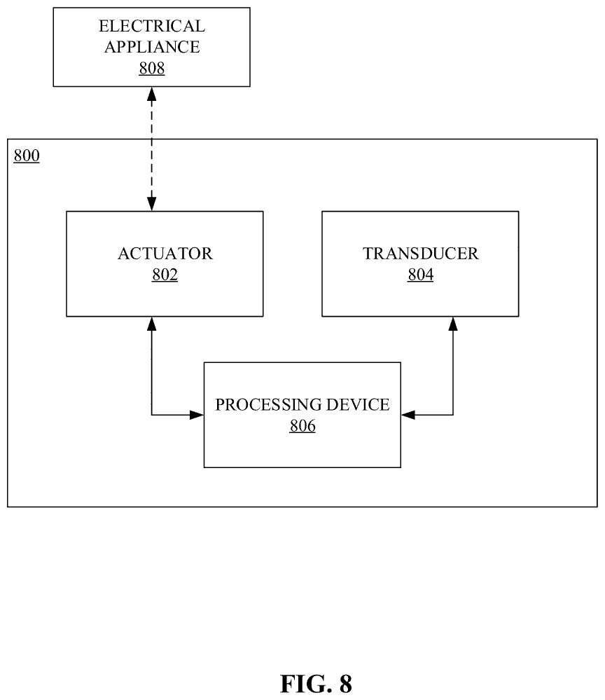

FIG. 8 is a block diagram of an apparatus 800 to facilitate controlling of an electrical appliance 808. Further, the electrical appliance 808 may include a device that may be configured to provide heat as an output upon consumption of a power source. For instance, the electrical appliance 808 may include a clothes iron configured to produce heat through consumption of electricity by heating of an electric coil. Further, in an instance, the heating device may include a room heater configured to produce heat through consumption of electricity by heating of an electric coil.

Further, the apparatus 800 may include at least one transducer 804 configured to detect at least one environmental variable associated with an output device of a pre-deployed sensor unit. Further, the apparatus 800 may include at least one actuator 802 coupled to the heating device 808. Further, the at least one actuator 802 may be configured for controlling an operational state of the heating device 808. Further, the apparatus may include a processing device 806 communicatively coupled to each of the at least one transducer 804 and the at least one actuator 802. Further, the processing device 806 may be configured for controlling the operational state of the heating device based on the detection of the at least one environmental variable. Further, apparatus 800 may include a power source configured to power the apparatus 800. Further, the power source may include at least one of a removable power source, and an irremovable power source. Further, the removable power source may include a battery, including, but not limited to a Nickel-Cadmium (NiCd or NiCad) battery, a Nickel metal hydride (Ni-MH) battery, and a Lithium ion (Li-Ion) battery. Further, in an embodiment, the battery may be rechargeable through an external energy source, such as through a wired charger, or through a wireless charger through induction. Further, in an embodiment, the irremovable power source may include a connection to electrical mains, such as through a wired plug.

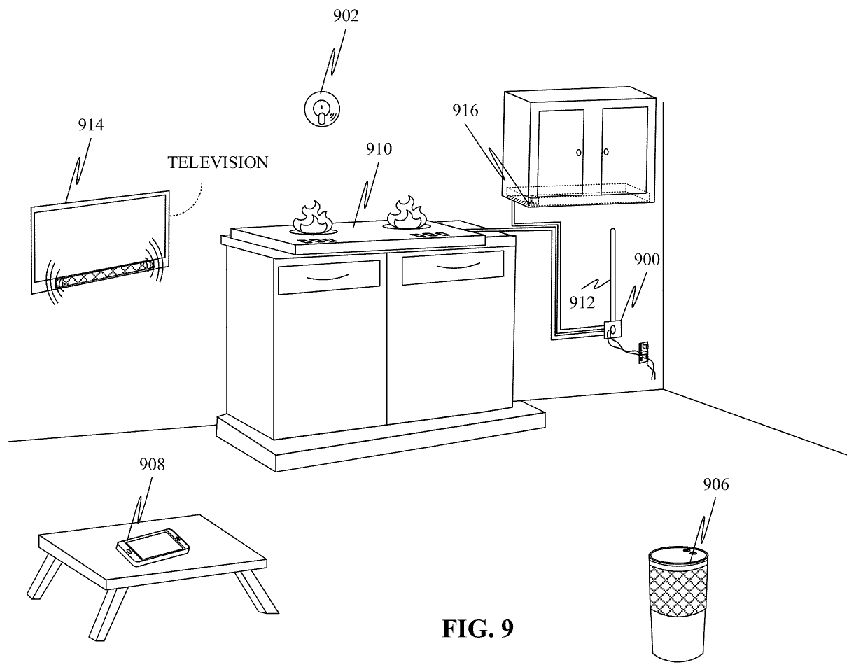

FIG. 9 is an exemplary illustration of an apparatus 900 to facilitate a user with an override feature to control an actuator of the apparatus 900 when a false alert signal is received, in accordance with some embodiments.

Further, the apparatus 900 may facilitate controlling of a heating device, such as a stove, to in response to the false alert signal. Further, the apparatus 900 may include an actuator coupled to the heating device. Further, actuator may be configured for controlling an operational state of the heating device. Further, the apparatus 900 may include a transducer, and a processing device.

Further, in an embodiment, the apparatus 900 may be configured for receiving an alarm sound produced by a sensor or an alarm such as a smoke sensor 902 through a home automation system 906. Further, the alarm sound may be produced by the smoke sensor 902 to indicate a hazardous or emergency situation. Further, the home automation system 906 may include a virtual assistant that may control lighting, climate, entertainment systems, and appliances in a home. Further, the home automation system 906 may be configured to receive sounds such as the alarm sound.

Further, in an embodiment, the transducer of the apparatus 900 may be configured to convert variations in a physical quantity, such as pressure, brightness, sound, and so on, as produced by an output device of a pre-deployed sensor unit into an electrical signal.

Further, in some embodiments, the output device may include a speaker. Further, the transducer may include a sound detector. Further, in some embodiments, the pre-deployed sensor unit may include the smoke sensor 902 configured to generate a sound through the output device upon detection of smoke. Further, in some embodiments, the output device of may include a light emitter. Further, the transducer may include a light detector.

Further, in some embodiments, the pre-deployed sensor unit may include a fire alarm configured to emit a light pattern through the output device upon detection of a fire. Further, in some embodiments, the transducer may be configured to detect an environmental parameter associated with an environment in which the apparatus may be deployed. Further, the environmental parameter may include at least one of temperature, humidity, pressure, light, sound, vibration, wind and motion of objects. Further, the processing device may be configured for controlling the operational state of a heating device, such as a gas stove 910 based on the detection of the at least one environmental variable.

Further, a specialized alarm may be utilized that may transmit an alarming signal over a Wi-Fi network directly to the apparatus 900. Accordingly, the apparatus 900 may close the supply of fuel for the gas stove 910 as illustrated in the figure. Further, in an instance, the home automation system 906 may be configured to transmit a notification to the user on a user device 908 over a communication network, such as Wi-Fi, Bluetooth, ZigBee, cellular network, and so on. For instance, detection of smoke by the smoke sensor 902 may result in an alarm sound. The alarm sound may be a loud sound produced by speakers that may be embedded inside the smoke sensor 902. Further, the alarm sound that may be received by the home automation system 906, may be converted into an alarming signal using a transducer such as a microphone that may be embedded in the home automation system 906. In some embodiments, the user or occupants may be hearing impaired and may not hear the alarming sound produced by the smoke sensor 902. Accordingly, the smoke sensor 902 may be configured to emit light patterns that may be detected or recognized by the home automation system 902 and transmitted to the user device 908 as well as to the apparatus 900. Further, the apparatus 900 may be located in between the gas stove 910, and a fuel supply line 912. Further, apparatus 900 may include a control valve that may control the flow of fuel as illustrated in FIG. 13. For example, when the electrical signal is transmitted to the apparatus 900 from the home automation system 906, the relay may close immediately, that may allow an electrical signal to energize the solenoid 1302 which may result in closing the valve 1304. Accordingly, when the electrical signal is removed, the valve may reopen, that may allow fuel to flow through fuel supply line 1306. So, when the electrical signal is transmitted to the apparatus 900, the apparatus 900 may close the valve, thus restricting a flow of fuel. Further, in an embodiment, the apparatus 900 may include a circuit breaker switch 916 wired on to the valve and mounted on to an upper cabinet recess. The circuit breaker switch 916 may activate when the electrical signal may be transmitted to the valve, locking the valve in a closed configuration. The circuit breaker switch 916 may prop up, requiring the user to reset the circuit breaker switch, and provide a software override signal to remove the electrical signal, reopening the valve. Further, in an embodiment, an override signal may be transmitted from the user device 908 to the to the apparatus 900. The override signal may be a signal to counteract the normal operation of any device such as at least one actuator associated with the apparatus, such as the at least one actuator 202. For instance, the alarm signal may be false as the user may know an origin of the alarm sound to be an alternate device, such as a television 914 in the vicinity of the user as well as the home automation system 906 rather than from the smoke detector. Further, in an instance, the user may transmit the override signal from the user device 908, such as through a mobile application. Further, the apparatus 900 may receive the override signal from the user device 908 using a transceiver embedded inside the apparatus 900. Accordingly, the at least one actuator may allow the flow of fuel. Further, in an embodiment, the user device 908, through the mobile application may be used to override shut-off by the at least one actuator, re-set the at least one actuator, override the at least one actuator, and program the at least one actuator. For example, voice recognition may be utilized to override the at least one actuator. Further, in an embodiment, the apparatus 900 may be configured to stop a flow of fuel to the gas stove 910 by closing a fuel valve (such as the valve 1304) in the fuel supply line 912 configured to supply fuel to the gas stove 910. Further, the apparatus 900 may be configured to be positioned between the fuel supply line 912 and the gas stove 910. Further, the apparatus 900 may be configured to act as a conduit for fuel from the fuel supply line 912 to the gas stove. Further, the apparatus 900 may include a fuel passage with a first end configured to interface with the fuel supply line 912, and a second end configured to interface with a fuel inlet of the gas stove.

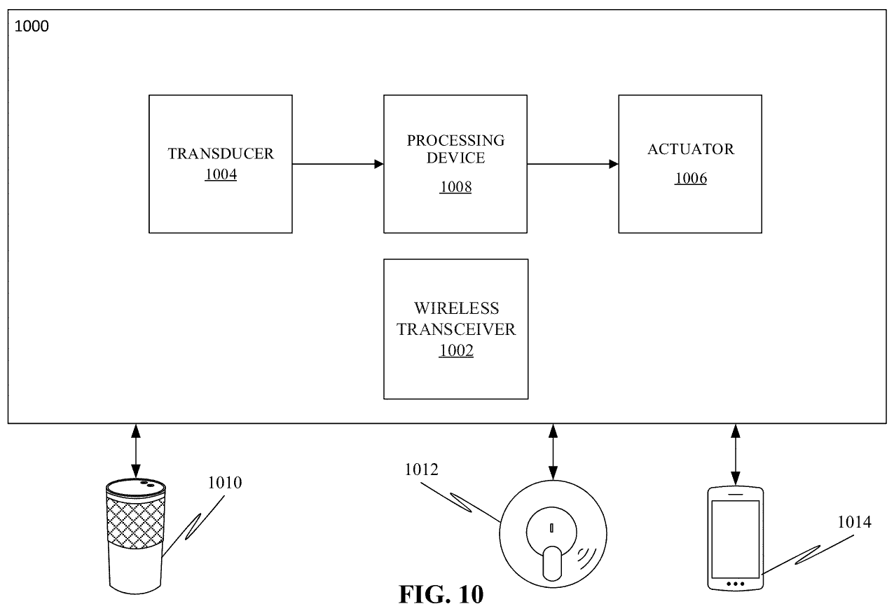

FIG. 10 is a block diagram of an apparatus 1000 to facilitate a user with an override feature to control the apparatus 1000 when a false alert signal is received using a wireless communication network. Further, a home automation system 1010 communicating with the apparatus 1000 may include a virtual assistant that may control lighting, climate, entertainment systems, and appliances of an environment where the apparatus 1000 may be installed, such as a home environment. The home automation system 1010 may also receive sounds such as an alarm sound from a sensor, such as a smoke sensor 1012 installed in a vicinity of home automation system 1010. Further, the home automation system 1010 may be configured to transmit a notification to a user device 1014 corresponding to the alarm over a wireless network. For instance, detection of smoke by the smoke detector may result in the alarming sound.

Further, the apparatus 1000 may communicate with other devices such as the home automation system 1010, smoke sensor 1012, user device 1014 etc. using a wireless transceiver 1002. For an instance, the wireless transceiver 1002 may be configured for receiving as well as transmitting signals over the wireless network such as Wi-Fi. For example, a user may transmit an override signal from the user device 1014 to the apparatus 1000 over the wireless network. Further, the apparatus 1000 may include a transducer 1004, such as a microphone to receive the sound produced by a sensor or alarm such as the smoke sensor 1012 present in the vicinity of the apparatus 1000. Further, the transducer 1004 may further convert the sound into an alarming signal that may be transmitted to the user device 1014 over a wireless network using the wireless transceiver 1002. Further, the apparatus 1000 may include an actuator 1006. Further, the actuator 1006 may be configured for moving and controlling a connected mechanism or system. For instance, the actuator 1006 herein may allow the flow of fuel based on the override signal and may stop the flow of fuel as per the alarming signal. Further, the apparatus 1000 may include a processing device 1008 configured to control the actuator 1006 based on detection of an alarm signal (as detected by the transducer 1004, or received via the wireless transceiver 1002). Further, the user device 1014 may include an electronic device such as, but not limited to, a smartphone, a computer tablet, a laptop, and so on. The user device 1014 may include a communication device configured to communicate over a communication network such as, but not limited to, a cellular network, a satellite network, a personal area network, Bluetooth, Internet and so on. Further, the user device 1014 may receive notification from the apparatus 1000 as well as the home automation system 1010, and may transmit instructions such as the override signal to the apparatus 1000. In an exemplary embodiment, the apparatus 1000 may be embedded within gas stoves present on travel trailers, moto coaches, recreational vehicles and boats etc. Further, the apparatus 1000 may receive an alarming signal directly from a smoke alarm using Wi-Fi, Bluetooth, voice recognition, or hardwire that may automatically disable the gas stove.

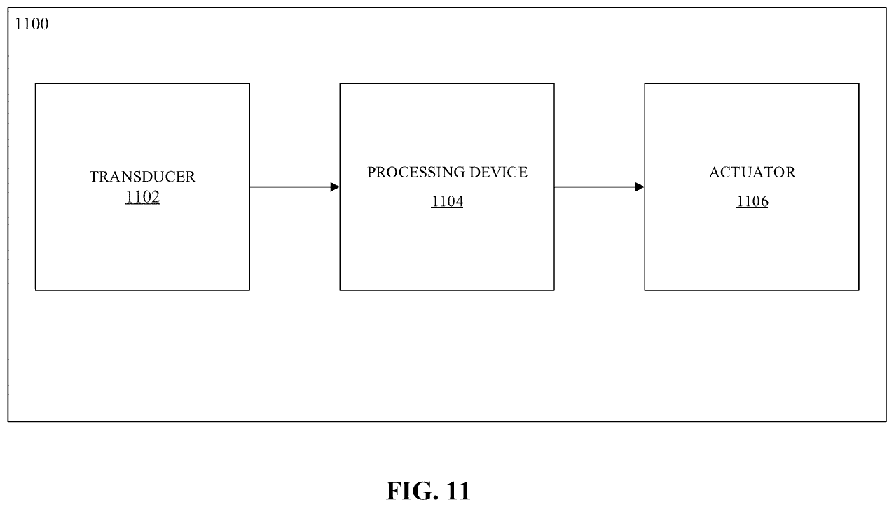

FIG. 11 is a block diagram of an apparatus 1100 to facilitate a user with an override feature to control an actuator 1106 when a false alert signal is received by the apparatus 1100, in accordance with some embodiments. The apparatus 1100 may include a transducer 1102, a processing device 1104, and an actuator 1106. The transducer 1102 may be configured to convert variations in a physical quantity, such as pressure, brightness, sound, and so on, as produced by an output device of a pre-deployed sensor unit into an electrical signal. For instance, the transducer 1102 such as a microphone may convert the sound waves into the electrical signal. For example, the sound waves produced by a smoke detector may be converted into an alarming signal.

Further, in some embodiments, the output device may include a speaker. Further, the transducer 1102 may include a sound detector. Further, in some embodiments, the pre-deployed sensor unit may include a smoke alarm configured to generate a sound through the output device upon detection of smoke. Further, in some embodiments, the output device may include a light emitter. Further, the transducer 1102 may include a light detector.

Further, in some embodiments, the pre-deployed sensor unit may include a fire alarm configured to emit a light pattern through the output device upon detection of a fire. Further, in some embodiments, the transducer 1102 may be configured to detect an environmental parameter associated with an environment in which the apparatus 1100 may be deployed. Further, the environmental parameter may include at least one of temperature, humidity, pressure, light, sound, vibration, wind and motion of objects. Further, the processing device 1104 may be configured for controlling the operational state of a heating device an electric stove 1110, based on the detection of the at least one environmental variable.

Further, the processing device 1104 may be configured to analyze the alarming signal and preset function and to generate another electric signal (a control signal corresponding to the actuator 1106), such as an override signal for the actuator 1106. For instance, the preset function may be a function that is preprogrammed into the processing device 1104. For example, if the processing device 1104 receives an alarming signal, then a signal to close a fuel valve through the actuator 1106 may be generated by the processing device 1104.

Further, the actuator 1106 may be configured for moving and controlling a mechanism or system. For an instance, the actuator 1106 may allow the flow of fuel based on the override signal and may stop the flow of fuel as per the alarming signal.

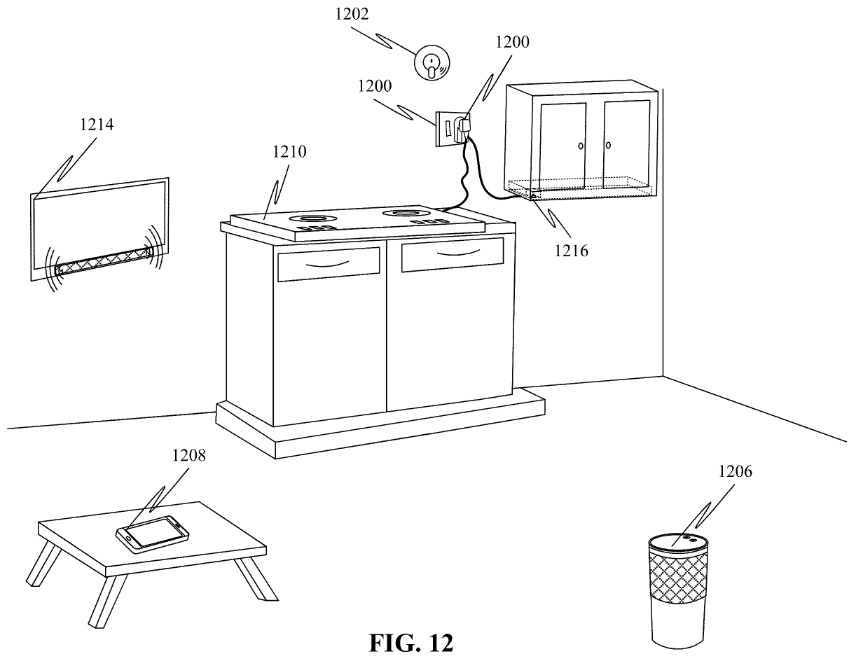

FIG. 12 is an exemplary illustration of an apparatus 1200 to facilitate a user with an override feature to control an actuator of the apparatus 1200 when a false alert signal is received, in accordance with some embodiments. Further, the apparatus 1200 may facilitate controlling of a heating device, such as a stove, to in response to the false alert signal. Further, the apparatus 1200 may include an actuator coupled to the heating device. Further, actuator may be configured for controlling an operational state of the heating device. Further, the apparatus 1200 may include a transducer, and a processing device.

Further, in an embodiment, the apparatus 1200 may be configured for receiving an alarm sound produced by a sensor or an alarm such as a smoke sensor 1202 through a home automation system 1206.

Further, in an embodiment, the transducer of the apparatus 1200 may be configured to convert variations in a physical quantity, such as pressure, brightness, sound, and so on, as produced by an output device of a pre-deployed sensor unit into an electrical signal.

Further, in some embodiments, the output device of the pre-deployed sensor unit configured to generate the output may include a speaker. Further, the transducer may include a sound detector. Further, in some embodiments, the pre-deployed sensor unit may include a smoke sensor 1202 configured to generate a sound through the output device upon detection of smoke. Further, in some embodiments, the output device may include a light emitter. Further, the transducer may include a light detector.

Further, in some embodiments, the pre-deployed sensor unit may include a fire alarm configured to emit a light pattern through the output device upon detection of a fire. Further, in some embodiments, the transducer may be configured to detect an environmental parameter associated with an environment in which the apparatus may be deployed. Further, the environmental parameter may include at least one of temperature, humidity, pressure, light, sound, vibration, wind and motion of objects. Further, the processing device may be configured for controlling the operational state of a heating device, such as a gas stove, or an electric stove, based on the detection of the at least one environmental variable.

Further, the alarm sound may be produced by the smoke sensor 1202 to indicate a hazardous or emergency situation. Further, the home automation system 1206 may include a virtual assistant that may control lighting, climate, entertainment systems, and appliances in a home. Further, the home automation system 1206 may be configured to receive sounds such as the alarm sound. Further, a specialized alarm may be utilized that may transmit an alarming signal over a Wi-Fi network directly to the apparatus 1200. Accordingly, the apparatus 1200 may close the supply of fuel for an electric stove 1210 as illustrated in the figure. Further, in an instance, the home automation system 1206 may be configured to transmit a notification to the user on a user device 1208 over a communication network, such as Wi-Fi, Bluetooth, ZigBee, cellular network, and so on. For instance, detection of smoke by the smoke sensor 1202 may result in an alarm sound. The alarm sound may be a loud sound produced by speakers that may be embedded inside the smoke sensor 1202. Further, the alarm sound that may be received by the home automation system 1206, may be converted into an alarming signal using a transducer such as a microphone that may be embedded in the home automation system 1206. In some embodiments, the user or occupants may be hearing impaired and may not hear the alarming sound produced by the smoke sensor 1202. Accordingly, the smoke sensor 1202 may be configured to emit light patterns that may be detected or recognized by the home automation system 1202 and transmitted to the user device 1208 as well as to the apparatus 1200. Further, the apparatus 1200 may be located in between the electric stove 1210, and a standard appliance outlet 1212.

Further, for the electric stove 1210, such as an induction heater, the apparatus 1200 may be integrated into the standard appliance outlet 1212. The standard appliance outlet 1212 may be replaced with apparatus and the electric stove 1210 may be plugged into the apparatus 1200. When triggered, a relay may interrupt the electrical power to the electric stove 1210. A circuit breaker switch 1216 mounted on an upper cabinet may be triggered, locking the relay, requiring the user to manually override the relay by resetting the circuit breaker switch 1216. Further, the apparatus 1200 may receive a signal from the home automation system 1206, or directly from the smoke alarm 1202 and may react to the alarm sound to disable the electric stove 1210.

Further, in an embodiment, an override signal may be transmitted from the user device 1208 to the to the apparatus 1200. The override signal may be a signal to counteract the normal operation of any device such as the actuator. For instance, the alarm signal may be false as the user may know an origin of the alarm sound to be an alternate device, such as a television 1214 in the vicinity of the user as well as the home automation system 1206 rather than from the smoke detector. Further, in an instance, the user may transmit the override signal from the user device 1208, such as through a mobile application. Further, the apparatus 1200 may receive the override signal from the user device 1208 using a transceiver embedded inside the apparatus 1200. Accordingly, the actuator may allow the flow of fuel. Further, in an embodiment, the user device 1208, through the mobile application may be used to override shut-off by the actuator, re-set the actuator, override the actuator, and program the actuator. For example, voice recognition may be utilized to override the actuator.

Further, the apparatus 1200 may be configured for controlling supply of electric power to the electric stove 1210. Further, the apparatus 1200 may include a plug configured to connect to electric mains supply. Further, the apparatus 1200 may include an electrical outlet electrically coupled to the plug. Further, the electrical outlet may be configured to receive a plug of the electrical stove 1210, and transmit electrical power from the electrical mains supply to the electrical stove. Further, the apparatus 1200 may include a circuit breaker switch electrically coupled to each of the plug and the electrical outlet. Further, the circuit breaker switch may be configured for controlling electrical continuity between the electric mains supply and the electrical outlet. Further, the circuit breaker switch may be communicatively coupled to the actuator. Further the circuit breaker switch may be activated based on detecting the at least one physical quantity.

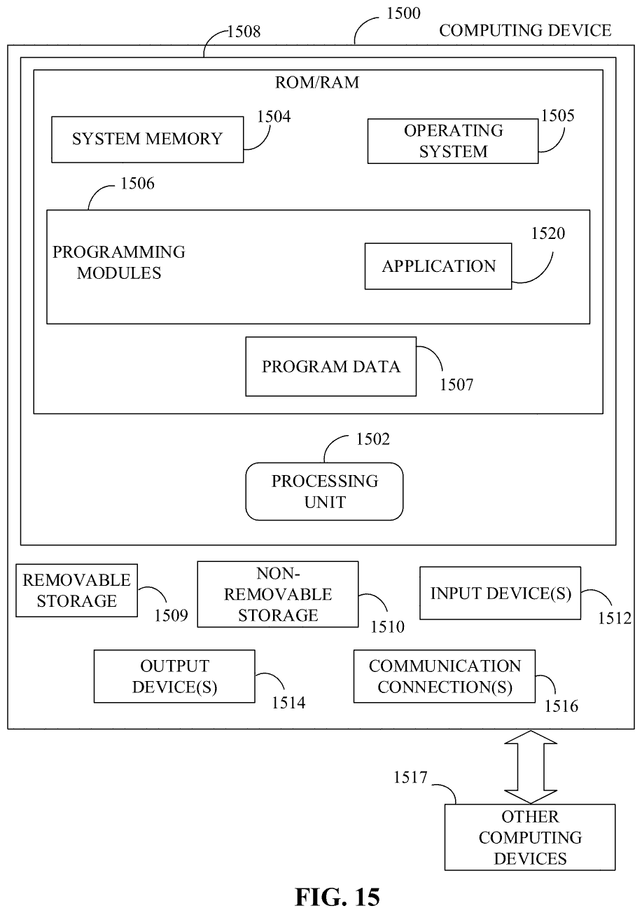

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500′s operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus to facilitate controlling of a heating device, the apparatus comprising:
at least one transducer configured to detect at least one environmental variable associated with an output device of a pre-deployed sensor unit;
at least one actuator coupled to the heating device, wherein the at least one actuator is configured for controlling an operational state of the heating device; and
a processing device communicatively coupled to each of the at least one transducer and the at least one actuator, wherein the processing device is configured for controlling the operational state of the heating device based on the detection of the at least one environmental variable.

2. The apparatus of claim 1, wherein the output device comprises a speaker, wherein the at least one transducer comprises a sound detector.

3. The apparatus of claim 2, wherein the pre-deployed sensor unit comprises a smoke alarm configured to generate a sound through the output device upon detection of smoke.

4. The apparatus of claim 1, wherein the output device comprises a light emitter, wherein the at least one transducer comprises a light detector.

5. The apparatus of claim 4, wherein the pre-deployed sensor unit comprises a fire alarm configured to emit a light pattern through the output device upon detection of a fire.

6. The apparatus of claim 1, wherein the heating device comprises a gas stove, wherein the at least one actuator is configured to stop a flow of fuel to the gas stove by closing a fuel valve in a fuel supply line configured to supply fuel to the gas stove.

7. The apparatus of claim 6 configured to be positioned between the fuel supply line and the gas stove, wherein the apparatus is configured to act as a conduit for fuel from the gas supply line to the gas stove, wherein the apparatus comprises a fuel passage with a first end configured to interface with the fuel supply line, and a second end configured to interface with a fuel inlet of the gas stove.

8. The apparatus of claim 1, wherein the heating device comprises an electric stove, wherein the at least one actuator is configured for controlling supply of electric power to the electric stove.

9. The apparatus of claim 8 comprising:
a plug configured to connect to electric mains supply;
an electrical outlet electrically coupled to the plug, wherein the electrical outlet is configured to receive a plug of the electrical stove, and transmit electrical power from the electrical mains supply to the electrical stove;
a circuit breaker switch electrically coupled to each of the plug and the electrical outlet, wherein the circuit breaker switch is configured for controlling electrical continuity between the electric mains supply and the electrical outlet, wherein the circuit breaker switch is communicatively coupled to the at least one actuator, wherein the processing device is configured to activate the circuit breaker switch based on detecting the at least one environmental variable.

10. The apparatus of claim 1 further comprising a power source configured to power the apparatus, wherein the power source comprises at least one of a removable power source, and irremovable power source.

11. The apparatus of claim 1 further comprising a transceiver communicatively coupled to the processing device, wherein the transceiver is configured to communicate with a home automation system associated with a premises of the heating device.

12. The apparatus of claim 11, wherein the transceiver is configured to receive at least one characteristic of the at least one environmental variable associated with the output device from the home automation system, wherein the detection of the at least one environmental variable is based on the at least one characteristic.

13. The apparatus of claim 11, wherein the transceiver is further configured to transmit a notification to a user device, wherein the processing device is configured to generate the notification based on the detection of the at least one environmental variable.

14. The apparatus of claim 11, wherein the transceiver is further configured to receive an actuating signal corresponding to the at least one actuator from the user device, wherein the actuator is configured for controlling the operational state of the heating device based on the actuating signal.

15. The apparatus of claim 12, wherein the transceiver is configured to receive a media content associated with at least one user device connected to the home automation system, wherein the processing device is further configured for:
analyzing the media content; and
determining a presence of the at least one characteristic in the media content based on the analyzing, wherein the controlling of the operational state of the heating device is further based on determining the presence of the at least one characteristic in the media content.

16. The apparatus of claim 1 comprising a memory device communicatively coupled to the processing device, wherein the memory device is configured for storing and retrieving at least one digital signature associated with an output of the output device.

17. The apparatus of claim 16, wherein the processing device is configured to compare a signal generated by the at least one transducer with the at least one digital signature to determine an authenticity of the output, wherein the processing device is configured for controlling the operational state of the heating device based on the determining of the authenticity.

18. The apparatus of claim 1, wherein the at least one transducer is configured to detect an environmental parameter associated with an environment in which the apparatus is deployed, wherein the environmental parameter comprises at least one of temperature, humidity, pressure, light, sound, vibration, wind and motion of objects.

19. An apparatus to facilitate controlling of an electrical appliance, the apparatus comprising:
at least one transducer configured to detect at least one environmental variable associated with an output of a pre-deployed sensor unit;
at least one actuator coupled to the heating device, wherein the at least one actuator is configured for controlling an operational state of the heating device; and
a processing device communicatively coupled to each of the at least one transducer and the at least one actuator, wherein the processing device is configured for controlling the operational state of the heating device based on the detection of the at least one environmental variable.

20. The apparatus of claim 19 comprising a power source configured to power the apparatus, wherein the power source comprises at least one of a removable power source, and an irremovable power source.
